(19) United States
(12) Patent Application Publication
(10) Pub. No.: US 2013/0038009 A1
(43) Pub. Date: Feb. 14, 2013

(54) VISE WITH PUSH DEVICE

(71) Applicant: CHIN-YUAN LEE, CHANGHUA COUNTY (TW)

(72) Inventor: CHIN-YUAN LEE, CHANGHUA COUNTY (TW)

(21) Appl. No.: 13/468,044

(22) Filed: May 10, 2012

(30) Foreign Application Priority Data
Aug. 12, 2011 (TW) 100215056

(51) Int. Cl. B25B 1/24

(52) U.S. Cl. 269/90

(57) ABSTRACT

A vise includes a body and a fixed jaw connected to the body, a movable jaw, a driving unit, and a push unit. The body has a guide member and the driving unit has a threaded rod which is co-axially connected to the movable jaw. A locking member is threadedly mounted to the threaded rod. The push device has a slide mounted to the guide member, a joint member connected to the slide and a cylinder connected to the slide. The slide has a groove and the joint member has a pivot which is engaged with the groove. When activating the cylinder, the movable jaw is moved toward to or away from the fixed jaw by the joint member and the locking member, and the clamping force is magnified.

### BACKGROUND OF THE INVENTION

(1) Field of the Invention

The present invention relates to a vise, and more particularly, to a vise with a push device which magnifies the force for clamping objects.

(2) Description of the Prior Art

One of the conventional vises is disclosed in Taiwan Utility Model No. M344941 and discloses a body with a threaded rod located within the body, a movable jaw threadedly connected to the threaded rod, a push rod located in the threaded rod, and a push device which is located corresponding to the push device. The push device has an activation member and a joint member, wherein the activation member is driven by the push rod and the joint member is activated by the activation member. When the push rod is activated, the activation member drives the joint member which acts between an extended position and a folded position. The actions of the joint member drive the threaded rod so that the movable jaw is moved toward or away from the fixed jaw.

However, the push device includes too many parts and has complicated structure which requires higher manufacturing cost and longer assembly time.

The present invention intends to provide a vise with a push device which has simple structure and is easily assembled.

### SUMMARY OF THE INVENTION

The present invention relates to a vise and comprises a body extending along the longitudinal direction and has a first end and a second end which is located in opposite and along the longitudinal direction to the first end. The second end has a guide member located along the longitudinal direction. A fixed jaw is fixed to the first end and a movable jaw is connected to the body and located corresponding to the fixed jaw. A driving unit has a threaded rod which is co-axially connected to the movable jaw. A locking member is threadedly mounted to the threaded rod. A push device has a slide which is mounted to the guide member. A joint member is connected to the slide and a cylinder is connected to the slide. The slide has a groove and the joint member has a pivot which is engaged with the groove. A first link is pivotably connected the pivot and the body. A second link is pivotably connected between the pivot and the locking member. The cylinder drives the slide to move along the longitudinal direction.

The primary object of the present invention is to provide a push unit for the vise and the movable jaw is movable toward or away from the fixed jaw by the push unit. The push unit has a cylinder which drives the joint member and the locking member to move the movable jaw and the clamping force between the fixed and movable jaw is magnified.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show the vise with the push device of the present invention;

FIG. 2 is a cross sectional view to show the vise with the push device of the present invention, wherein the movable jaw is in contact with the fixed jaw, and

FIG. 3 is a cross sectional view to show the vise with the push device of the present invention, wherein the movable jaw is separated from the fixed jaw.

### DETAILED DESCRIPTION OF THE PREFERRED EMBODIMENT

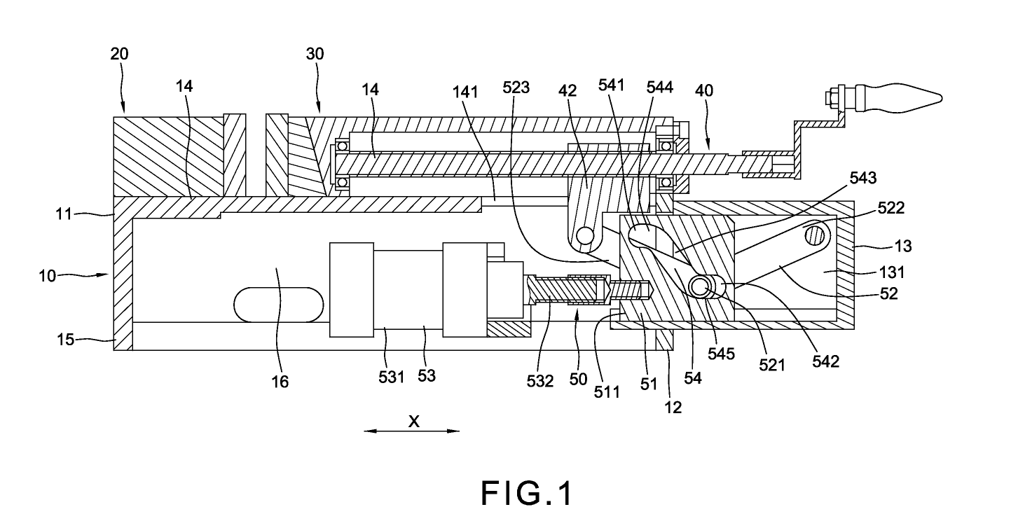

Referring to FIG. 1, the vise of the present invention comprises a body 10 extending along a longitudinal direction “X” and the body 10 has a first end 11 and a second end 12 which is located in opposite and along the longitudinal direction “X” to the first end 11. A fixed jaw 20 is fixed to the first end 11 and the second end 12 has a guide member 13 located along the longitudinal direction “X”. The guide member 13 of the body 10 is a hollow member and has a guide hole 131 which extends along the longitudinal direction “X”. The body 10 has a top board 14 and multiple end boards 15 extend downward from the top board 14. A space 16 is defined between the top board 14 and the multiple end boards 15. The top board 14 has a slot 141 which reaches the space 16.

A movable jaw 30 is connected to the body 10 and located corresponding to the fixed jaw 20. The movable jaw 30 is moveable along the top board 14.

A driving unit 40 has a threaded rod 41 which is co-axially connected to the movable jaw 30. A locking member 42 is threadedly mounted to the threaded rod 41 and reaches the space 16. A push device 50 has a slide 51 which is located in the guide hole 131 of the guide member 13. A joint member 52 is connected to the slide 51 and a cylinder 53 is connected to the slide 51. The slide 51 of the push device 50 has a first side 511 and a second side 512 which is located in opposite to the first side 511 along the longitudinal direction “X”. The first side 511 is connected with the cylinder 53. The slide 51 has a groove 54 which extends from the first side 511 to the second side 512. The grove 54 has a top dead point 541 located corresponding to the first side 511 and a bottom dead point 542 located corresponding to the second side 512. An inclined section 543 is located between the top and bottom dead points 541, 542. The groove 54 of the slide 51 of the push device 50 has a first buffering section 544 and a second buffering section 545. The first buffering section 544 is connected between the top dead point 541 and the inclined section 543, and the second buffering section 545 is connected between the bottom dead point 542 and the inclined section 543. The joint member 52 has a pivot 521 which is engaged with the groove 54. A first link 522 is pivotably connected the pivot 521 and the body 10. A second link 523 is pivotably connected between the pivot 521 and the locking member 42.

The cylinder 53 is located in the space 16 and has a cylindrical case 531 and a piston rod 532 is movably inserted into the cylindrical case 531. The piston rod 532 is connected to the slide 51 so as to drive the slide 51 to move along the longitudinal direction “X”.

As shown in FIG. 1, the piston rod 532 is in the retracted position relative to the cylindrical case 531, and the slide 51 is located in the space 16. The bottom dead point 542 is located corresponding to the pivot 521. The joint member 52 is in a folded status. The movable jaw 30 is indirectly driven by the joint member 52 and located away from the fixed jaw 20.

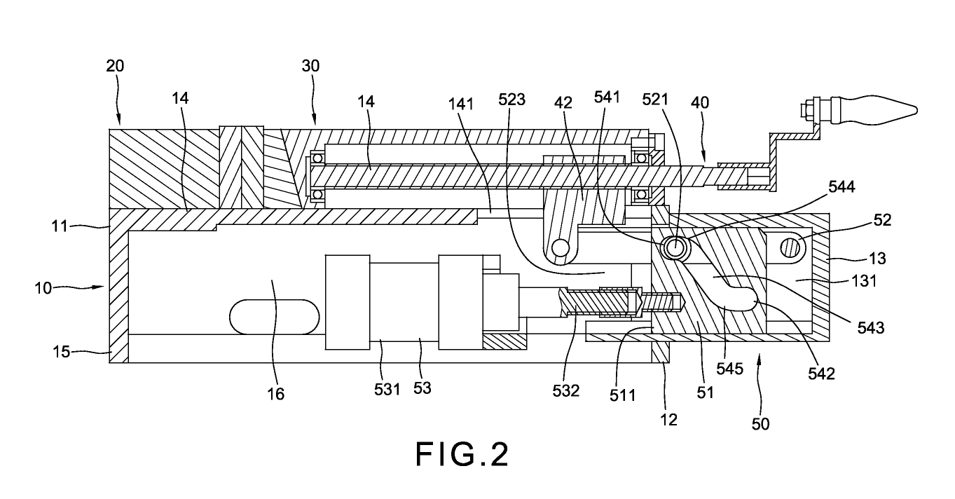

As shown in FIG. 2, when the piston rod 532 extends away from the cylindrical case 531, the slide 51 moves away from the space 16 and the top dead point 541 is located corresponding to the pivot 521. The joint member 52 is in an expanded status. The movable jaw 30 is indirectly driven by the joint member 52 and moves toward the fixed jaw 20 to clamp an object (not shown) between the fixed and movable jaws 20, 30. When the slide 51 moves along the guide hole 131, by the guidance of the bottom dead point 542, the second buffering section 545, the inclined section 543 and the first buffering section 544, the pivot 521 moves smoothly. By the first buffering section 544, the movable jaw 30 is buffered when approaching the fixed jaw 20 to prevent form hard impact.

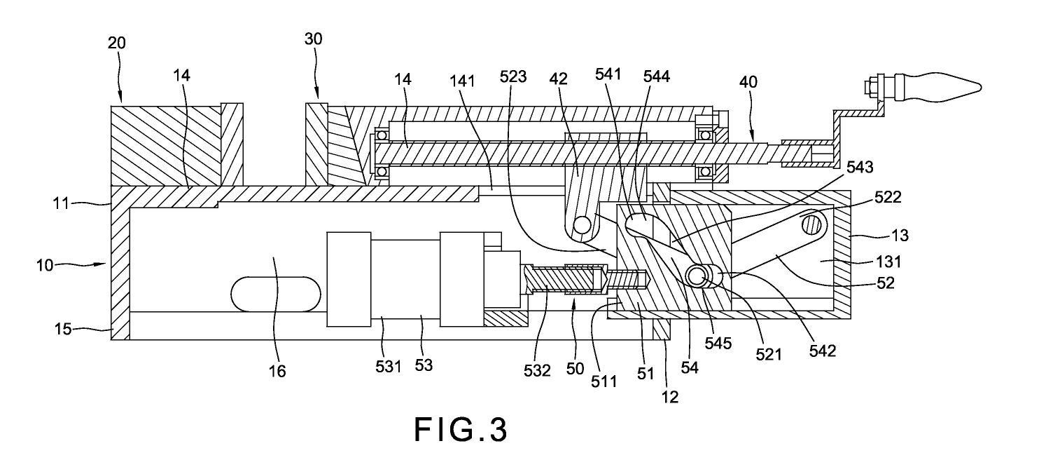

As shown in FIG. 3, when the size of the object is changed, the user rotates the threaded rod 41 of the driving unit 40, because the locking member 42 is restricted and positioned by the joint member 52, the distance between the fixed and movable jaws 20, 30 can be adjusted.

By the actions of the piston rod 532 relative to the cylindrical case 53, the slide 51 moves along the guide member 13 and the movable jaw 30 is driven by the joint member 52 so that the movable jaw 30 can move quickly toward or remove from the fixed jaw 20 with magnified force.

While we have shown and described the embodiment in accordance with the present invention, it should be clear to those skilled in the art that further embodiments may be made without departing from the scope of the present invention.

What is claimed is:

1. A vise comprising:
a body extending along a longitudinal direction and having a first end and a second end which is located in opposite and along the longitudinal direction to the first end, the second end having a guide member located along the longitudinal direction;
a fixed jaw fixed to the first end;
a movable jaw connected to the body and located corresponding to the fixed jaw;
a driving unit having a threaded rod which is co-axially connected to the movable jaw, a locking member threadedly mounted to the threaded rod, and
a push device having a slide which is located in the guide member, a joint member connected to the slide and a cylinder connected to the slide, the slide having a groove and the joint member having a pivot which is engaged with the groove, a first link pivotably connected the pivot and the body, a second link pivotably connected between the pivot and the locking member, the cylinder driving the slide to move along the longitudinal direction.

2. The vise as claimed in claim 1, wherein the body has a top board and multiple end boards extend downward from the top board, a space is defined between the top board and the multiple end boards, the top board has a slot through which the locking member extends and reaches the space, the cylinder is located in the space.

3. The vise as claimed in claim 2, wherein the guide member of the body is a hollow member and has a guide hole which extends along the longitudinal direction, the slide is engaged with the guide hole.

4. The vise as claimed in claim 3, wherein the slide of the push device has a first side and a second side which is located in opposite to the first side along the longitudinal direction, the first side is connected with the cylinder, the groove extends from the first side to the second side, the grove has a top dead point located corresponding to the first side and a bottom dead point located corresponding to the second side, an inclined section is located between the top and bottom dead points.

5. The vise as claimed in claim 4, wherein the groove of the slide of the push device has a first buffering section and a second buffering section, the first buffering section is connected between the top dead point and the inclined section, the second buffering section is connected between the bottom dead point and the inclined section.
